(19) United States
(12) Patent Application Publication
(10) Pub. No.: US 2005/0134885 A1
(43) Pub. Date: Jun. 23, 2005

(54) Image scanning apparatus

(75) Inventor: Yong-kon Jo, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/965,893

(22) Filed: Oct. 18, 2004

(30) Foreign Application Priority Data
Dec. 3, 2003 (KR) 2003-87167

(51) Int. Cl. G06K 15/16; H04N 1/04

(52) U.S. Cl. 358/1.12; 358/498

(57) ABSTRACT

An image scanning apparatus having a scanning portion for scanning a document sheet, and a printing portion for printing an image on a recording sheet, includes: a frame installed on the printing portion, the frame configured to receive a series of components of the scanning portion for scanning a document sheet.

### CROSS-REFERENCE TO RELATED APPLICATION

This application claims the benefit of Korean Application No. 2003-87167, filed Dec. 3, 2003, in the Korean Intellectual Property Office, the disclosure of which is incorporated herein by reference.

### BACKGROUND OF THE INVENTION

1. Field of the Invention

The present invention relates to an image scanning apparatus, and more particularly, to an image scanning apparatus having a single frame structure in which a series of components of a scanning portion to scan an image is integrally disposed at one frame.

2. Description of Related Art

In general, an image scanning apparatus such as a facsimile or the like has a scanning portion for scanning a document sheet, and a printing portion for forming an image on a recording medium using image data.

FIG. 1 is a perspective view illustrating a portion of an example of a conventional image scanning apparatus, and FIG. 2 is a side section view illustrating the conventional image scanning apparatus.

Referring to FIGS. 1 and 2, an image scanning apparatus includes a printing portion 30 at a lower portion of a main body 10, and a scanning portion 20 at an upper portion of the main body 10.

The scanning portion 20 has a pickup roller 21 installed in the main body to pick up a document sheet, a feed roller 22 for feeding the document sheet picked up by the pickup roller 21 to the downstream side thereof, an image sensor 24 for scanning the document sheet, and a white roller 23 installed to face the image sensor 24 with the document sheet interposed therebetween for transferring the document sheet to the downstream side.

A lower frame 25 is pivotably installed to be able to pivot upward at an upper side of the pickup roller 21, the feed roller 22 and the image sensor 24, and an upper frame 26 is pivotably installed at an upper side of the lower frame 25 to be able to pivot upward. A sheet transfer path S is provided through a gap (space) formed between the upper frame 26 and the lower frame 25 so that a document sheet to be scanned can be transferred along the sheet transferring path S.

Since a scanning operation panel 27 is installed at an upside of the upper frame 26 to be able to pivot upward, a user can perform operations required for scanning a document sheet by means of the scanning operation panel 27.

The printing portion 30 prints image data on a recording sheet, and discharges the image printed sheet to the outside via the sheet transfer path P.

In the above conventional image scanning apparatus, since the lower frame 25 is installed on the main body 10, the upper frame 26 is installed on the lower frame 25, and the scanning operation panel 27 is installed on the upper frame 26, the number of components of the scanning portion for scanning a document sheet is great, and the structure of the scanning portion is complex. Therefore, the material cost of the scanning portion increases, and the assembling jobs thereof cannot be efficiently performed. These factors negatively affect the competitiveness of the image scanning apparatus. In particular, there is a problem in which the reliability of the image scanning apparatus decreases due to accumulation of assembling tolerances during assembling various components.

### BRIEF SUMMARY

To solve the above-described and/or other problems, embodiments of the present invention provide an image scanning apparatus having enhanced reliability by installing components of a scanning portion at an integrated frame.

According to an aspect of the present invention, there is provided an image scanning apparatus having a scanning portion for scanning a document sheet, and a printing portion for printing an image on a recording sheet, including: a frame installed on the printing portion, the frame configured to receive a series of components of the scanning portion for scanning a document sheet.

The apparatus may include a discharged printed sheet bed which guides an image printed sheet so as to allow the image printed sheet to be discharged from the printing portion and to be stacked thereon.

According to another aspect of the present invention, there is provided an image scanning apparatus including: a printing section; and a scanning section detachably coupled to an upper side of the printing section, the scanning portion having a frame in which components for scanning a document sheet are disposed.

A scanning portion of an apparatus, including a frame having a component receiving portion which receives scanning components. The scanning portion includes plural scanning components. The plural scanning components are received by the frame.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a perspective view illustrating a portion of a conventional image scanning apparatus;

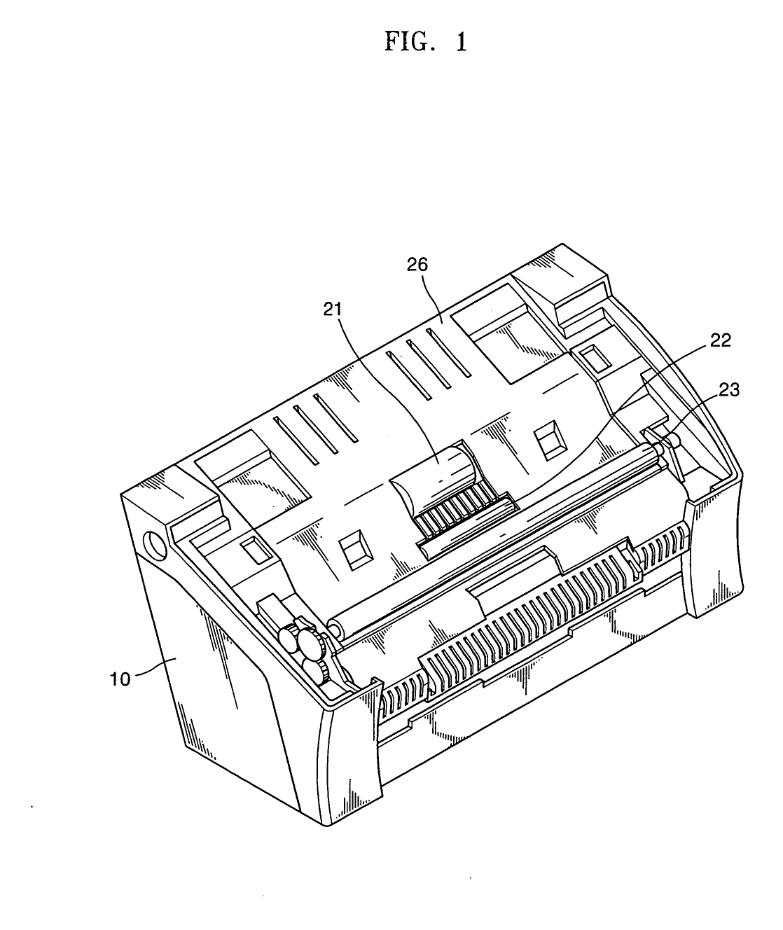

FIG. 2 is a side section view of the conventional image scanning apparatus of FIG. 1;

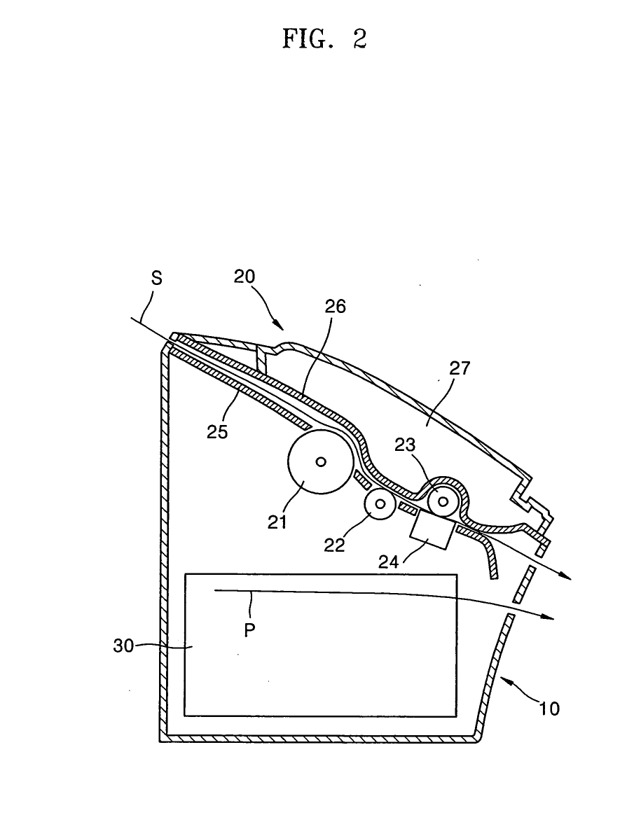

FIG. 3 is an exploded perspective view illustrating an image scanning apparatus according to an embodiment of the present invention;

FIG. 4 is a side view illustrating the image scanning apparatus shown in FIG. 3; and

FIG. 5 is a perspective view illustrating a scanning portion of the image scanning apparatus shown in FIG. 3.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

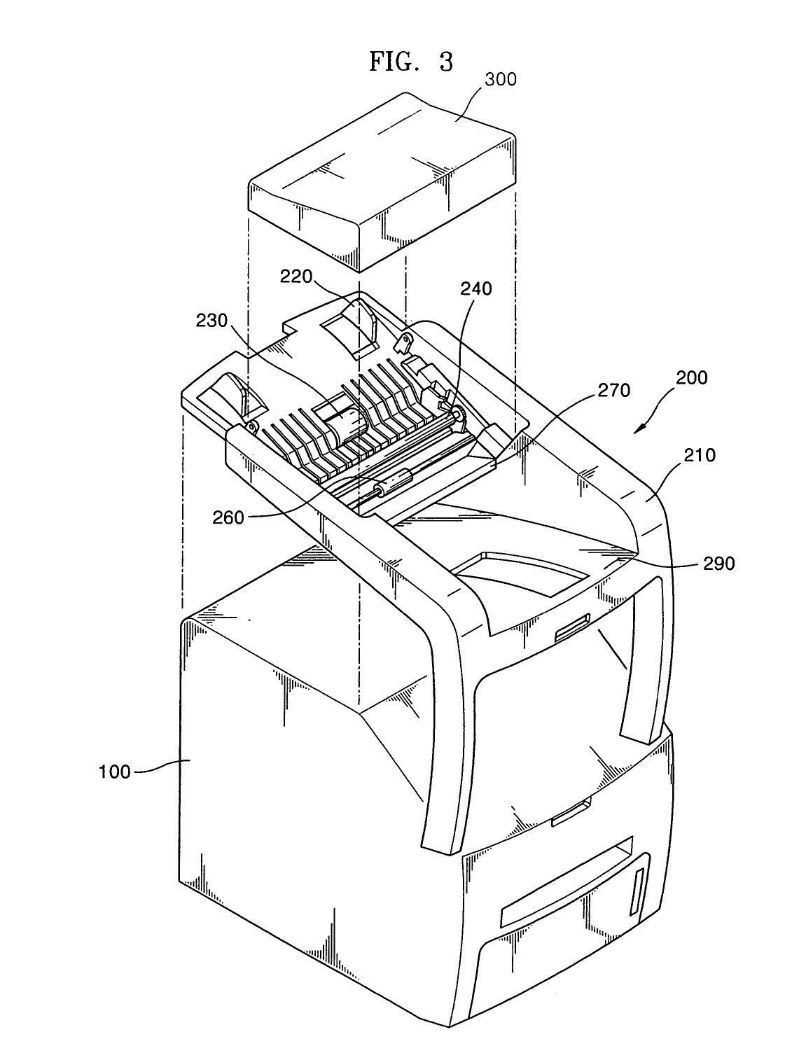

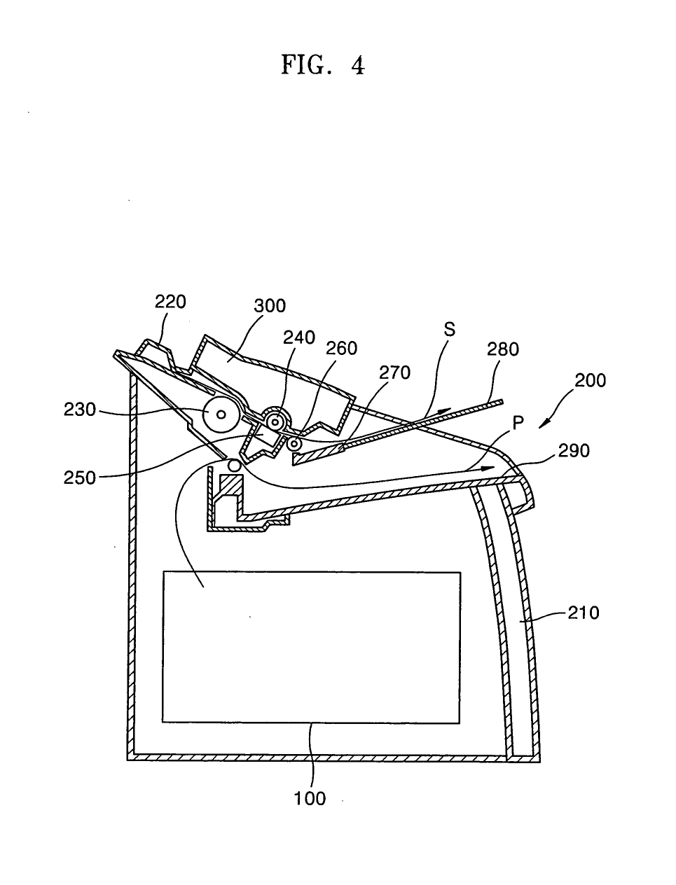

Referring to FIGS. 3 and 4, an image scanning apparatus according to an embodiment of the present invention has a printing portion 100, a scanning portion 200, and an operation portion 300.

The printing portion 100 which forms an image on a recording sheet is positioned at a lower part of the image scanning apparatus.

The scanning portion 200 is installed to be detachable at the upper side of the printing portion 100 so as to scan a document sheet, and all the components for scanning a document sheet are provided in frame 210 in an assembled shape (configuration).

That is, the scanning portion 200 has one integrally molded frame 210, and the components for scanning a document sheet are disposed in the frame 210.

Provided at the integrated frame 210 are a document supporting bed portion 220 which can be adjusted to fit the size of document sheets to be scanned so as to support both sides of document sheets, a pickup roller 230 for picking up a document sheet laid on the document supporting bed portion 220, an image sensor 250 for scanning an image formed on the document sheet picked up by the pickup roller 230, a white roller 240 installed to face the image sensor 250 with the document sheet interposed therebetween for causing the document sheet to be pressed toward the image sensor 250, a discharging roller 260 for discharging the document sheet the image of which has been scanned by the image sensor 250 to the outside, and a document guide portion 270 for guiding the document sheet scanned by the image sensor 250 so as to allow the scanned document sheet to be discharged.

A discharged document sheet bed 280 on which discharged document sheets are to be stacked is detachably installed at the rear end of the document guide portion 270.

A discharged printed sheet bed 290 on which discharged printed sheets on which respective images are formed and which are discharged from the printing portion 100 are to be stacked is provided below the document guide portion 270. A recording sheet on which an image is formed at the printing portion 100 is guided by the lower portion of the document guide portion 270 and is stacked on the discharged printed sheet bed 290.

When the scanning portion 200 is installed on the printing portion 100, the scanning portion 200 is connected to a driving power source (not shown) provided at the printing portion 100 so as to drive the pickup roller 230, the white roller 240, and the discharging roller 260, and receives driving power from the driving power source (not shown) and is driven by the driving power.

The operation portion 300 is installed on the upper portion of the scanning portion 200, and is provided with various buttons for controlling the image scanning apparatus.

The operation of the image scanning apparatus configured as described above according to the present embodiment will be described with reference to FIGS. 3-5.

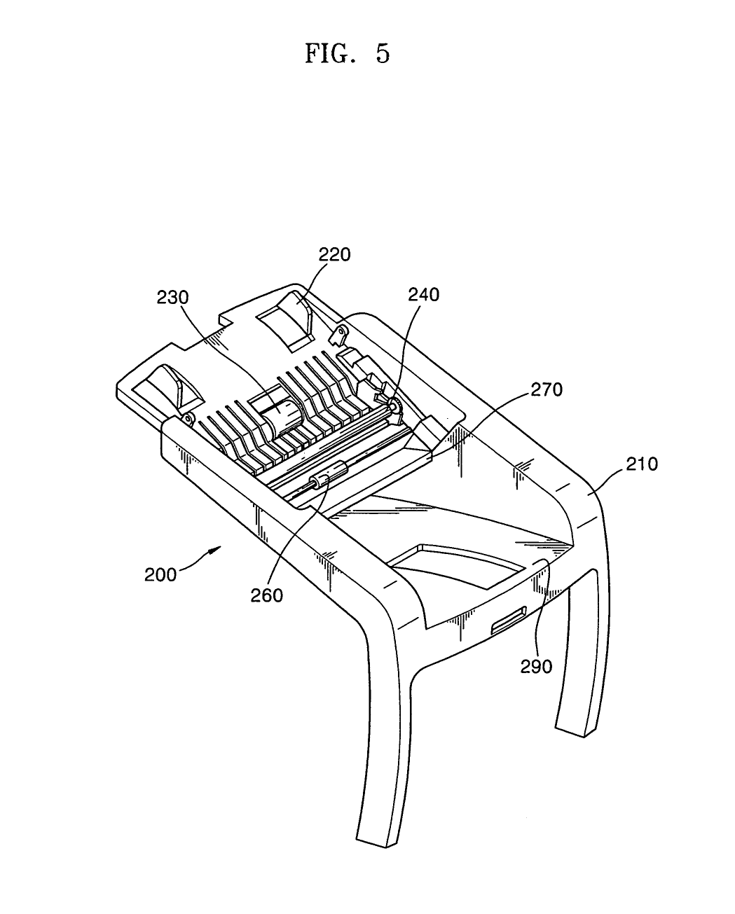

Referring to FIG. 5, a document sheet laid on the document supporting bed portion 220 is transported between the image sensor 250 and the white roller 240 by the pickup roller 230, and an image formed on the document sheet is scanned by the image sensor 250.

The document sheet the image of which has been scanned by the image sensor 250 is transferred to the discharging roller 260 and is stacked on the discharged document sheet bed 280 via the document guide portion 270. A document sheet laid on the document supporting bed portion 220 is transported along a document sheet transfer path S formed by the scanning portion 200 and the operation portion 300, and is discharged to the discharged document sheet bed 280.

A recording sheet on which an image is formed at the printing portion 100 is discharged to the discharged printed sheet bed 290 along a recording sheet transfer path P formed when the scanning portion 200 is installed on the printing portion 100, while being guided by the lower portion of the document guide portion 270.

As described above, the reliability of the image scanning apparatus can be enhanced since the scanning portion is formed at one integrated frame and is configured to have a simple structure so as to be able to be detachable from the printing portion, and therefore ease of assembly of the apparatus can be enhanced and cumulative tolerance occurring between parts and components can be reduced.

Although an embodiment of the present invention have been shown and described, the present invention is not limited to the described embodiment. Instead, it would be appreciated by those skilled in the art that changes may be made in the embodiment without departing from the principles and spirit of the invention, the scope of which is defined by the claims and their equivalents.

1. An image scanning apparatus having a scanning portion for scanning a document sheet, and a printing portion for printing an image on a recording sheet, comprising:
a frame installed on the printing portion, the frame configured to receive a series of components of the scanning portion for scanning a document sheet.

2. The apparatus of claim 1, wherein the frame is detachably installed in the frame.

3. The apparatus of claim 1, wherein the frame is integrally molded.

4. The apparatus of claim 1, further comprising a discharged printed sheet bed which guides an image printed sheet so as to allow the image printed sheet to be discharged from the printing portion and to be stacked thereon, the printed sheet bed being disposed at the integrated frame.

5. The apparatus of claim 2, further comprising a document guide portion which guides a document sheet scanned by the scanning portion, the document guide portion being disposed at the integrated frame.

6. The apparatus of claim 5, wherein the discharged printed sheet bed is located below the document guide portion.

7. The apparatus of claim 1, wherein when the scanning portion is installed on the printing portion, the scanning portion is connected to a power source so as to receive driving power for driving the components.

8. The apparatus of claim 1, wherein the components include: an adjustable document supporting bed adjustable to fit a size of a document sheet so as to support sides of the document sheet; a pickup roller which picks up a document sheet laid on the document supporting bed; an image sensor which scans an image formed on the document sheet picked up by the pickup roller; an image sensor; a white roller facing the image sensor and spacedly disposed therefrom to cause a document sheet interposed therebetween to be pressed toward the image sensor; a discharging roller which discharges the document sheet the image of which has been scanned by the image sensor, and a document guide portion which guides the document sheet scanned by the image sensor so as to allow the scanned document sheet to be discharged.

9. An image scanning apparatus comprising:
a printing section; and
a scanning section detachably coupled to an upper side of the printing section, the scanning portion having a frame in which components for scanning a document sheet are disposed.

10. The apparatus of claim 9, wherein the frame is integrally molded.

11. A scanning portion of an apparatus, comprising:
a frame having a component receiving portion which receives scanning components,
wherein the scanning portion includes plural scanning components, and
wherein the plural scanning components are received by the frame.
